(19) United States
(12) Patent Application Publication
(10) Pub. No.: US 2010/0179341 A1
(43) Pub. Date: Jul. 15, 2010

(54) PROCESS FOR CONVERTING SI-H COMPOUNDS TO SI-HALOGEN COMPOUNDS

(75) Inventors: Konrad Mautner, Riesa (DE); Werner Geissler, Thiendorf (DE); Gudrun Tamme, Moritzburg (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/665,862

(22) PCT Filed: Jun. 11, 2008
(86) PCT No.: PCT/EP2008/057256

§ 371 Date: Jan. 4, 2010

(30) Foreign Application Priority Data
Jul. 4, 2007 (DE) 10 2007 030 949.1

(51) Int. Cl. C07F 7/12

(52) U.S. Cl. 556/477

(57) ABSTRACT

Silicon compounds containing Si—H groups are converted into silicon halides by reaction with hydrogen halide in the gas phase in the presence of a catalyst of gamma-alumina, which is also effective in dissociating hydrocarbons which may be present into lower boiling hydrocarbons.

The invention relates to a process for converting Si—H compounds into Si-halogen compounds in the gas phase by means of hydrogen halide.

In the preparation of halosilanes or organohalosilanes, mixtures which also contain Si—H-containing silanes are frequently obtained. The silanes can be desirable and can be isolated in pure form from the mixtures. However, they can also be undesirable and therefore have to be removed. The most common method of fractionating silane mixtures is distillation. If the boiling points of Si—H-containing silanes and one or more other silanes are quite close together or an azeotrope is formed, the distillation becomes complicated and costly.

U.S. Pat. No. 5,336,799 A describes the conversion of Si—H-containing compounds into the corresponding organosilanes by reaction with organic halides over Pt or Pd catalysts. The reaction rates are slow and comparatively expensive organic halides are required.

EP 423948 A describes the reaction of Si—H-containing organosilanes with hydrogen halide over metal catalysts such as Pd, Pt, Ni to form organohalosilanes. The catalysts are expensive and deactivation of the catalysts by slow oxidation to metal halides takes place.

U.S. Pat. No. 5,302,736 A describes Ag or Au catalysts for this purpose, but the reaction proceeds too slowly.

U.S. Pat. No. 3,754,077 A describes the conversion of halosilanes having one or more Si—H bonds into tetrahalosilane in the gas phase by means of hydrogen halide over solid catalysts such as activated carbon, Al₂O₃ or SiO₂. The process has been developed only for silanes without an organic radical and requires temperatures at or above 200° C.

It is an object of the invention to provide an improved process for converting the Si—H-containing silanes into silanes having altered boiling points.

The invention provides a process for converting silicon compounds (H) which have Si—H bonds into silicon compounds (Cl) which have Si-halogen bonds, wherein the silicon compounds (H) are reacted in the gas phase with hydrogen halide in the presence of gamma-aluminum oxide.

The process proceeds at relatively low temperatures and is suitable for all vaporizable silicon compounds (H) which have Si—H bonds. The gamma-aluminum oxide catalyst has very long operating lives and is very easy to handle.

Preferred silicon compounds (H) which have Si—H bonds are organopolysiloxanes, organopolysilanes and in particular monosilanes.

The silanes (H) preferably have the general formula 1

RₓSiH₄₋ₓ (1),

where
R is a monovalent, C₁-C₁₈-hydrocarbon radical which may be substituted by halogen radicals or is a halogen radical and
x is 1, 2 or 3.

The C₁-C₁₈-hydrocarbon radicals R are preferably phenyl radicals or C₁-C₆-alkyl radicals, a vinyl or allyl radical, in particular methyl or ethyl radicals.

Halogen substituents on R are preferably fluorine, chlorine and bromine, in particular chlorine.

Halogen radicals R are preferably fluorine, chlorine and bromine, in particular chlorine.

The process of the invention is suitable for use in the purification of crude products and prepurified products from the direct synthesis of methylchlorosilanes, in particular of methylchlorosilanes which contain, as by-products, silicon compounds (H), in particular EtHSiCl₂, and possibly further by-products.

The preferred concentration of silicon compounds (H) in the methylchlorosilanes is from 10 to 5000 ppm.

Hydrocarbons which are likewise formed as by-products of the direct synthesis of methylchlorosilanes are dissociated into lower-boiling hydrocarbons.

The hydrogen halide used is preferably hydrogen chloride or hydrogen bromide, in particular hydrogen chloride.

Preference is given to using from 1.5 to 50 mol, in particular from 3 to 10 mol, of hydrogen halide per mole of hydrogen of the silicon compounds (H).

The gamma-aluminum oxide used is used as powder or in the form of shaped bodies. The pore volume is preferably at least 80%. The BET surface area is preferably at least 200 m²/g, in particular at least 300 m²/g.

Pressure and temperature can be varied within wide ranges and are preferably matched to the conditions of an upstream column which provides a fraction enriched in silicon compounds (H), in particular EtHSiCl₂.

The process of the invention is preferably carried out at temperatures of at least 50° C., in particular at least 80° C., and preferably at temperatures of not more than 190° C., in particular not more than 150° C.

The process of the invention is preferably carried out in a tube reactor, with the mixture preferably being fed in in vapor form.

All symbols in the above formulae have their meanings independently of one another in each case.

In the following example, all amounts and percentages are, unless indicated otherwise, by weight, all pressures are 0.10 MPa (abs.) and all temperatures are 20° C.

### EXAMPLE

A tube reactor which has an internal diameter of 50 mm and a length of 600 mm and is heated by means of a heat-transfer medium is charged with 1 l of commercial gamma-aluminum oxide extrudate having a pore volume of 87% and a BET surface area of 244 m²/g. 600 g/h of a methylchlorosilane fraction containing 360 ppm of ethyldichlorosilane and 1300 ppm C₇-C₈ hydrocarbons are passed together with 2 l/h of hydrogen chloride through the catalyst at a temperature of the heat-transfer medium of 110° C. and a gauge pressure of 1 bar. The product condensed is analyzed by means of GC. It does not contain any ethyldichlorosilane; 85% of the C₇-C₈ hydrocarbons are dissociated to propane and butane.

1.-5. (canceled)

6. A process for converting silicon compounds which have Si—H bonds into silicon compounds which have Si-halogen bonds, comprising reacting the silicon compounds having Si—H bonds in the gas phase at a temperature of from 50° C. to 190° C. with hydrogen halide in the presence of a gamma-aluminum oxide catalyst.

7. The process of claim 6, wherein the silicon compounds are silanes of the formula 1
RₓSiH₄₋ₓ (1),
where
R is a monovalent, C₁-C₁₈-hydrocarbon radical optionally substituted by halogen radicals or is a halogen radical and
x is 1, 2 or 3.

8. The process of claim 6, wherein the hydrogen halide is hydrogen chloride.

9. The process of claim 7, wherein the hydrogen halide is hydrogen chloride.

10. The process of claim 6, wherein the BET surface area of the gamma-aluminum oxide is at least 200 m²/g.

11. The process of claim 7, wherein the BET surface area of the gamma-aluminum oxide is at least 200 m²/g.

12. The process of claim 9, wherein the BET surface area of the gamma-aluminum oxide is at least 200 m²/g.

13. The process of claim 9, wherein the BET surface area of the gamma-aluminum oxide is at least 200 m²/g.
